(19) United States
(12) Patent Application Publication
(10) Pub. No.: US 2024/0095608 A1
(43) Pub. Date: Mar. 21, 2024

(54) METHOD AND SYSTEM FOR INTELLIGENT ITINERARY MANAGEMENT

(71) Applicant: JPMorgan Chase Bank, N.A., New York, NY (US)

(72) Inventors: Jerome JOSEPH, Lewis Center, OH (US); Kumar Rao KRISHNAGI, Powell, OH (US); Kritsakorn CHAUMPANICH, Columbus, OH (US)

(73) Assignees: JPMorgan Chase Bank, N.A., New York, NY (US); JPMorgan Chase Bank, N.A., New York, NY (US)

(21) Appl. No.: 17/946,701

(22) Filed: Sep. 16, 2022

(51) Int. Cl. G06Q 10/02

(52) U.S. Cl. CPC G06Q 10/025

(57) ABSTRACT

A method for facilitating intelligent itinerary management via a progressive reservation system is disclosed. The method includes aggregating itinerary information for a user from user transactions, the itinerary information corresponding to a transit reservation; continuously monitoring, in real-time via an application programming interface, the transit reservation by using the itinerary information; determining, based on a result of the continuous monitoring, whether parameters that correspond to the transit reservation satisfy a predetermined threshold, the parameters including an operational status; automatically retrieving, from a repository, historical information that corresponds to the user when the parameters satisfy the predetermined threshold; automatically identifying, in real-time using a model, a future transit reservation based on the itinerary information and the historical information; and providing, via a graphical user interface, the identified future transit reservation to the user.

### BACKGROUND

### 1. Field of the Disclosure

This technology generally relates to methods and systems for itinerary management, and more particularly to methods and systems for facilitating intelligent itinerary management via a progressive reservation system that uses machine learning to recursively curate user data and automatically provide alternative recommendations.

### 2. Background Information

Many payment processors facilitate electronic transactions between users and common carriers such as, for example, airlines. Traditionally, the payment processors serve a passive role in these transactions between the users and the common carriers due to technological limitations. Historically, implementations of conventional itinerary management techniques by the payment processors have resulted in varying degrees of success with respect to effective administration of reservations that are associated with the electronic transactions.

One drawback of using the conventional itinerary management techniques is that in many instances, the payment processors may not be aware of trip interruptions such as, for example, flight delays and flight cancelations that materially alter the reservations. As a result, the impetus is on the user to find suitable alternatives, which may involve another payment processor. Additionally, due to numerous user variables such as, for example, a seat preference and an airline preference, providing recommendations of suitable alternatives may not be feasible for the payment processors with the conventional itinerary management techniques.

Therefore, there is a need to facilitate intelligent itinerary management via a progressive reservation system that uses machine learning to recursively curate user data and automatically provide alternative recommendations.

### SUMMARY

The present disclosure, through one or more of its various aspects, embodiments, and/or specific features or sub-components, provides, inter alia, various systems, servers, devices, methods, media, programs, and platforms for facilitating intelligent itinerary management via a progressive reservation system that uses machine learning to recursively curate user data and automatically provide alternative recommendations.

According to an aspect of the present disclosure, a method for facilitating intelligent itinerary management via a progressive reservation system is disclosed. The method is implemented by at least one processor. The method may include aggregating itinerary information for at least one user from a plurality of user transactions, the itinerary information may correspond to at least one transit reservation; continuously monitoring, in real-time via an application programming interface, each of the at least one transit reservation by using the itinerary information; determining, based on a result of the continuous monitoring, whether at least one parameter that corresponds to the at least one transit reservation satisfies a predetermined threshold, the at least one parameter may include an operational status; automatically retrieving, from a repository, historical information that corresponds to the at least one user when the at least one parameter satisfies the predetermined threshold; automatically identifying, in real-time by using at least one model, at least one future transit reservation based on the itinerary information and the historical information; and providing, via a graphical user interface, the identified at least one future transit reservation to the at least one user.

In accordance with an exemplary embodiment, the itinerary information may include at least one from among passenger information, real-time departure information, real-time arrival information, transit location information, terminal information, gate information, transit duration information, and real-time transit status information.

In accordance with an exemplary embodiment, to aggregate the itinerary information from the plurality of user transactions, the method may further include continuously monitoring, in real-time, transaction activities of the at least one user, the transaction activities may include at least one electronic purchasing activity; retrieving transaction data for each of the at least one electronic purchasing activity; filtering the transaction data to identify at least one travel related transaction; and extracting the itinerary information from each of the identified at least one travel related transaction.

In accordance with an exemplary embodiment, the operational status may include at least one from among an on-time status, a delayed status, and a canceled status.

In accordance with an exemplary embodiment, the historical information may include user specific data from a plurality of past reservations, the user specific data may include at least one from among departure location data, destination location data, price data, traversal time data, and user preference data.

In accordance with an exemplary embodiment, to automatically identify the at least one future transit reservation, the method may further include recursively curating, by using the at least one model, the historical information and the itinerary information; and invoking the application programming interface to identify the at least one future transit reservation based on an outcome of the curating, the application programming interface may include an external transit checker.

In accordance with an exemplary embodiment, the method may further include determining, by using the at least one model, a compatibility factor between the at least one transit reservation and the at least one future transit reservation; scoring, by using the at least one model, each of the at least one future transit reservation based on the compatibility factor; and ranking each of the at least one future transit reservation based on the corresponding score.

In accordance with an exemplary embodiment, to provide the identified at least one future transit reservation to the at least one user, the method may further include generating a hyperlink for the at least one user, the hyperlink may enable access to a portal that includes a listing of the at least one future transit reservation for selection; generating a notification, the notification may include the hyperlink and information that relates to at least one from among the itinerary information, an output of the determining, and the operational status; and providing, via the graphical user interface, the generated notification to the at least one user.

In accordance with an exemplary embodiment, the at least one model may include at least one from among a machine learning model, a mathematical model, a process model, and a data model.

According to an aspect of the present disclosure, a computing device configured to implement an execution of a method for facilitating intelligent itinerary management via a progressive reservation system is disclosed. The computing device including a processor; a memory; and a communication interface coupled to each of the processor and the memory, wherein the processor may be configured to aggregate itinerary information for at least one user from a plurality of user transactions, the itinerary information may correspond to at least one transit reservation; continuously monitor, in real-time via an application programming interface, each of the at least one transit reservation by using the itinerary information; determine, based on a result of the continuous monitoring, whether at least one parameter that corresponds to the at least one transit reservation satisfies a predetermined threshold, the at least one parameter may include an operational status; automatically retrieve, from a repository, historical information that corresponds to the at least one user when the at least one parameter satisfies the predetermined threshold; automatically identify, in real-time by using at least one model, at least one future transit reservation based on the itinerary information and the historical information; and provide, via a graphical user interface, the identified at least one future transit reservation to the at least one user.

In accordance with an exemplary embodiment the itinerary information may include at least one from among passenger information, real-time departure information, real-time arrival information, transit location information, terminal information, gate information, transit duration information, and real-time transit status information.

In accordance with an exemplary embodiment, to aggregate the itinerary information from the plurality of user transactions, the processor may be further configured to continuously monitor, in real-time, transaction activities of the at least one user, the transaction activities may include at least one electronic purchasing activity; retrieve transaction data for each of the at least one electronic purchasing activity; filter the transaction data to identify at least one travel related transaction; and extract the itinerary information from each of the identified at least one travel related transaction.

In accordance with an exemplary embodiment, the operational status may include at least one from among an on-time status, a delayed status, and a canceled status.

In accordance with an exemplary embodiment, the historical information may include user specific data from a plurality of past reservations, the user specific data may include at least one from among departure location data, destination location data, price data, traversal time data, and user preference data.

In accordance with an exemplary embodiment, to automatically identify the at least one future transit reservation, the processor may be further configured to recursively curate, by using the at least one model, the historical information and the itinerary information; and invoke the application programming interface to identify the at least one future transit reservation based on an outcome of the curating, the application programming interface may include an external transit checker.

In accordance with an exemplary embodiment, the processor may be further configured to determine, by using the at least one model, a compatibility factor between the at least one transit reservation and the at least one future transit reservation; score, by using the at least one model, each of the at least one future transit reservation based on the compatibility factor; and rank each of the at least one future transit reservation based on the corresponding score.

In accordance with an exemplary embodiment, to provide the identified at least one future transit reservation to the at least one user, the processor may be further configured to generate a hyperlink for the at least one user, the hyperlink may enable access to a portal that includes a listing of the at least one future transit reservation for selection; generate a notification, the notification may include the hyperlink and information that relates to at least one from among the itinerary information, an output of the determining, and the operational status; and provide, via the graphical user interface, the generated notification to the at least one user.

In accordance with an exemplary embodiment, the at least one model may include at least one from among a machine learning model, a mathematical model, a process model, and a data model.

According to an aspect of the present disclosure, a non-transitory computer readable storage medium storing instructions for facilitating intelligent itinerary management via a progressive reservation system is disclosed. The storage medium including executable code which, when executed by a processor, may cause the processor to aggregate itinerary information for at least one user from a plurality of user transactions, the itinerary information may correspond to at least one transit reservation; continuously monitor, in real-time via an application programming interface, each of the at least one transit reservation by using the itinerary information; determine, based on a result of the continuous monitoring, whether at least one parameter that corresponds to the at least one transit reservation satisfies a predetermined threshold, the at least one parameter may include an operational status; automatically retrieve, from a repository, historical information that corresponds to the at least one user when the at least one parameter satisfies the predetermined threshold; automatically identify, in real-time by using at least one model, at least one future transit reservation based on the itinerary information and the historical information; and provide, via a graphical user interface, the identified at least one future transit reservation to the at least one user.

In accordance with an exemplary embodiment, the itinerary information may include at least one from among passenger information, real-time departure information, real-time arrival information, transit location information, terminal information, gate information, transit duration information, and real-time transit status information.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating intelligent itinerary management via a progressive reservation system that uses machine learning to recursively curate user data and automatically provide alternative recommendations.

FIG. 4 is a flowchart of an exemplary process for implementing a method for facilitating intelligent itinerary management via a progressive reservation system that uses machine learning to recursively curate user data and automatically provide alternative recommendations.

FIG. 5 is a system architecture diagram of an exemplary process for implementing a method for facilitating intelligent itinerary management via a progressive reservation system that uses machine learning to recursively curate user data and automatically provide alternative recommendations.

FIG. 6 is a system sequence diagram of an exemplary process for implementing a method for facilitating intelligent itinerary management via a progressive reservation system that uses machine learning to recursively curate user data and automatically provide alternative recommendations.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

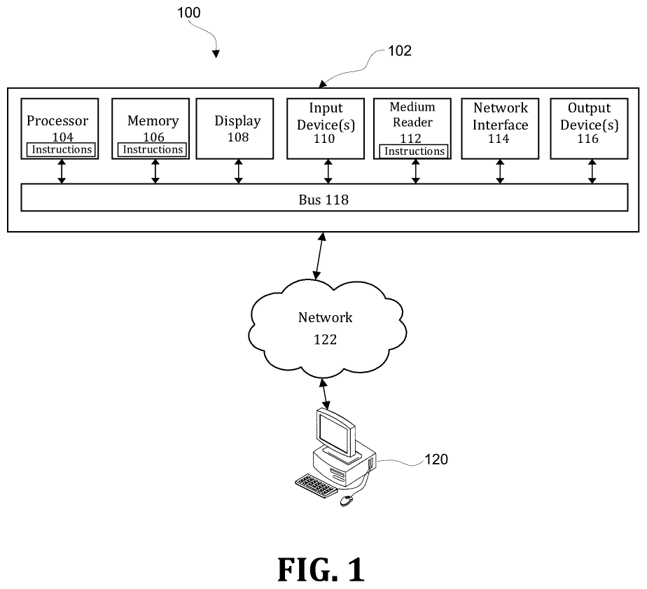

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating intelligent itinerary management via a progressive reservation system that uses machine learning to recursively curate user data and automatically provide alternative recommendations.

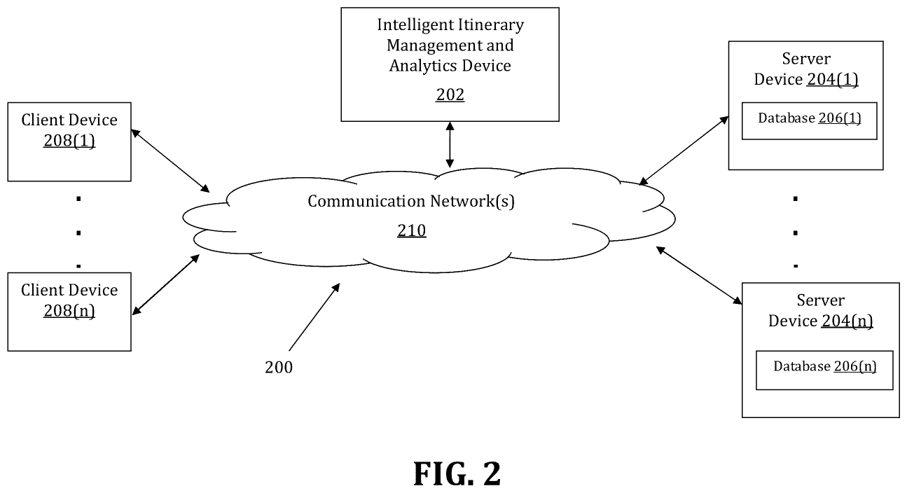

Referring to FIG. 2, a schematic of an exemplary network environment 200 for implementing a method for facilitating intelligent itinerary management via a progressive reservation system that uses machine learning to recursively curate user data and automatically provide alternative recommendations is illustrated. In an exemplary embodiment, the method is executable on any networked computer platform, such as, for example, a personal computer (PC).

The method for facilitating intelligent itinerary management via a progressive reservation system that uses machine learning to recursively curate user data and automatically provide alternative recommendations may be implemented by an Intelligent Itinerary Management and Analytics (IIMA) device 202. The IIMA device 202 may be the same or similar to the computer system 102 as described with respect to FIG. 1. The IIMA device 202 may store one or more applications that can include executable instructions that, when executed by the IIMA device 202, cause the IIMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the IIMA device 202 itself, may be located in virtual server(s) running in a cloud-based computing environment rather than being tied to one or more specific physical network computing devices. Also, the application(s) may be running in one or more virtual machines (VMs) executing on the IIMA device 202. Additionally, in one or more embodiments of this technology, virtual machine(s) running on the IIMA device 202 may be managed or supervised by a hypervisor.

In the network environment 200 of FIG. 2, the IIMA device 202 is coupled to a plurality of server devices 204(1)-204(n) that hosts a plurality of databases 206(1)-206(n), and also to a plurality of client devices 208(1)-208(n) via communication network(s) 210. A communication interface of the IIMA device 202, such as the network interface 114 of the computer system 102 of FIG. 1, operatively couples and communicates between the IIMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the IIMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and IIMA devices that efficiently implement a method for facilitating intelligent itinerary management via a progressive reservation system that uses machine learning to recursively curate user data and automatically provide alternative recommendations.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The IIMA device 202 may be a standalone device or integrated with one or more other devices or apparatuses, such as one or more of the server devices 204(1)-204(n), for example. In one particular example, the IIMA device 202 may include or be hosted by one of the server devices 204(1)-204(n), and other arrangements are also possible. Moreover, one or more of the devices of the IIMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the IIMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to itinerary information, user transactions, transit reservations, parameters, predetermined thresholds, operational statuses, historical information, and future transit reservations.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the IIMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the IIMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the IIMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the IIMA device 202, the server devices 204(1)-204(n), or the client devices 208(1)-208(n), for example, may be configured to operate as virtual instances on the same physical machine. In other words, one or more of the IIMA device 202, the server devices 204(1)-204(n), or the client devices 208(1)-208(n) may operate on the same physical device rather than as separate devices communicating through communication network(s) 210. Additionally, there may be more or fewer IIMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

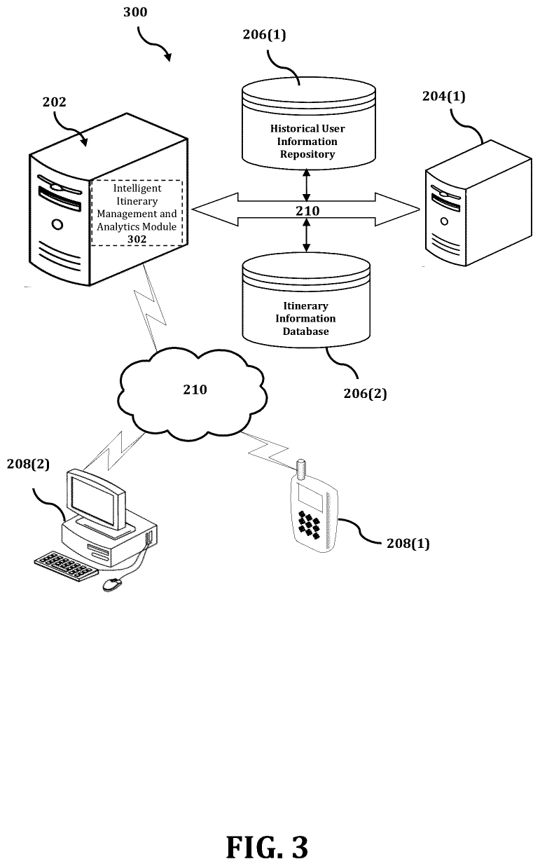

The IIMA device 202 is described and shown in FIG. 3 as including an intelligent itinerary management and analytics module 302, although it may include other rules, policies, modules, databases, or applications, for example. As will be described below, the intelligent itinerary management and analytics module 302 is configured to implement a method for facilitating intelligent itinerary management via a progressive reservation system that uses machine learning to recursively curate user data and automatically provide alternative recommendations.

An exemplary process 300 for implementing a mechanism for facilitating intelligent itinerary management via a progressive reservation system that uses machine learning to recursively curate user data and automatically provide alternative recommendations by utilizing the network environment of FIG. 2 is shown as being executed in FIG. 3. Specifically, a first client device 208(1) and a second client device 208(2) are illustrated as being in communication with IIMA device 202. In this regard, the first client device 208(1) and the second client device 208(2) may be “clients” of the IIMA device 202 and are described herein as such. Nevertheless, it is to be known and understood that the first client device 208(1) and/or the second client device 208(2) need not necessarily be “clients” of the IIMA device 202, or any entity described in association therewith herein. Any additional or alternative relationship may exist between either or both of the first client device 208(1) and the second client device 208(2) and the IIMA device 202, or no relationship may exist.

Further, IIMA device 202 is illustrated as being able to access a historical user information repository 206(1) and an itinerary information database 206(2). The intelligent itinerary management and analytics module 302 may be configured to access these databases for implementing a method for facilitating intelligent itinerary management via a progressive reservation system that uses machine learning to recursively curate user data and automatically provide alternative recommendations.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the IIMA device 202 via broadband or cellular communication. Of course, these embodiments are merely exemplary and are not limiting or exhaustive.

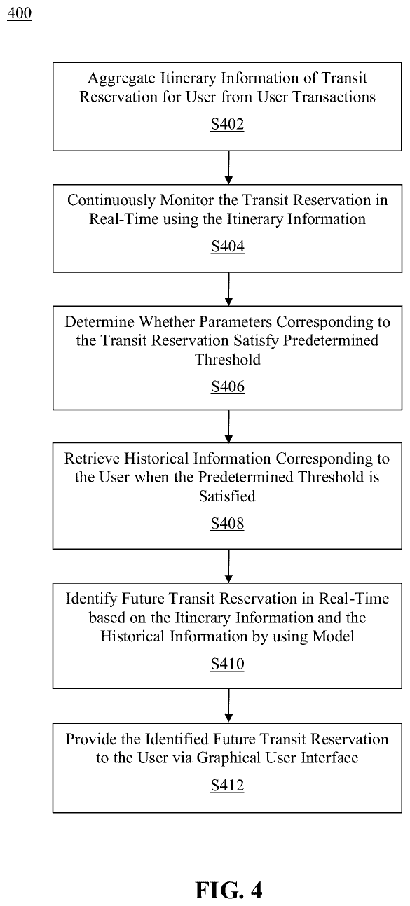

Upon being started, the intelligent itinerary management and analytics module 302 executes a process for facilitating intelligent itinerary management via a progressive reservation system that uses machine learning to recursively curate user data and automatically provide alternative recommendations. An exemplary process for facilitating intelligent itinerary management via a progressive reservation system that uses machine learning to recursively curate user data and automatically provide alternative recommendations is generally indicated at flowchart 400 in FIG. 4.

In the process 400 of FIG. 4, at step S402, itinerary information for users may be aggregated from a plurality of user transactions. The itinerary information may correspond to transit reservations of the users. In an exemplary embodiment, the itinerary information may relate to reservation details that have been extracted from user transaction data. The itinerary information may include at least one from among passenger information, real-time departure information, real-time arrival information, transit location information, terminal information, gate information, transit duration information, and real-time transit status information.

In another exemplary embodiment, to facilitate aggregation of the itinerary information from the plurality of user transactions, transaction activities of the users may be continuously monitored in real-time. The transaction activities may include electronic purchasing activities such as, for example, purchasing activities via a credit card and/or a debit card transaction. Then, the transaction data for each of the electronic purchasing activities may be retrieved and filtered to identify travel related transactions. Finally, the itinerary information may be extracted from each of the identified travel related transactions.

In another exemplary embodiment, the transit reservations may relate to arrangements between the users and a common carrier such as, for example, an airline to reserve a space on a corresponding mode of transit. For example, the transit reservation may relate to an airplane ticket that is booked with an airline for a seat on a particular flight. In another exemplary embodiment, the transit reservation may correspond to a travel document that records a route and/or a journey. For example, the transit reservation may correspond to a travel itinerary for a trip from one city to another.

At step S404, each of the transit reservations may be continuously monitored by using the itinerary information. The transit reservations may be continuously monitored in real-time via an application programming interface (API). In an exemplary embodiment, pertinent transit data may be identified from the itinerary information to facilitate the monitoring. The pertinent transit data may include at least one from among flight number data, airline name data, and airport location data. In another exemplary embodiment, pertinent user data may be identified from the itinerary information to facilitate the monitoring. The pertinent user data may include passenger information such as, for example, a passenger age and special user requests.

In another exemplary embodiment, the claimed system may provide the pertinent transit data and the pertinent user data to an external computing environment via the API to facilitate the continuous monitoring. The external computing environment may include a first-party computing network that manages the transit reservation. For example, the pertinent transit data and the pertinent user data may be provided to a corresponding airline network via an airline API to facilitate data retrieval for the continuous monitoring. Alternatively, the external computing environment may include a third-party computing network that aggregates data from the first-party computing network. For example, the pertinent transit data and the pertinent user data may be provided to a third-party data aggregator via an aggregator API to facilitate data retrieval for the continuous monitoring.

At step S406, whether parameters that correspond to the transit reservation satisfy predetermined thresholds may be determined. The determination may be made based on a result of the continuous monitoring. For example, the continuous monitoring may provide relevant flight data that may be usable to determine whether the predetermined thresholds are satisfied. In an exemplary embodiment, the parameters may include transit factors such as, for example, an operational status of the transit reservation. The operational status may include at least one from among an on-time status, a delayed status, and a canceled status.

In another exemplary embodiment, the transit factors may relate to circumstances that materially affect the transit reservation. The transit factors may include corresponding factor data that provide context for the circumstances. For example, the transit factors may indicate that the flight is delayed, and the corresponding factor data may provide that the delay is due to mechanical failures and expected to be resolved in three hours.

In another exemplary embodiment, the transit factors and the corresponding factor data may be compared to the predetermined threshold. The predetermined threshold may relate to a first threshold that has been automatically determined for the users based on historical user travel information as well as a second threshold that has been determined by the users based on personal preferences. For example, the users may interact with a graphical user interface to predetermine that flight delays that are expected to last longer than six hours require actions consistent with present disclosures.

At step S408, historical information that corresponds to the users may be automatically retrieved when the parameters satisfy the predetermined threshold. The historical information may be automatically retrieved from a user data repository. In an exemplary embodiment, the historical information may include user specific data from a plurality of past reservations. The user specific data may include at least one from among departure location data, destination location data, price data, traversal time data, and user preference data.

In another exemplary embodiment, the historical information may be automatically retrieved when at least one of the parameters satisfy the predetermined threshold. For example, the historical information may be automatically retrieved when a parameter relating to an expected delay time is satisfied even though another parameter relating to a flight status indicates that the flight is not yet canceled. In another exemplary embodiment, the historical information may be automatically retrieved when all of the parameters satisfy the predetermined threshold. Consistent with present disclosures, the historical information may be automatically retrieved based on satisfaction of any combination of the predetermined threshold by the parameters as defined by the users according to personal preference via the graphical user interface.

At step S410, future transit reservations may be automatically identified for the users based on the itinerary information and the historical information. The future transit reservations may be automatically identified in real-time by using models with predictive capabilities. In an exemplary embodiment, the future transit reservation may relate to an alternative transit reservation that is different from the initial transit reservation of the user. The future transit reservation may share common characteristics with the initial transit reservation. For example, when flight A is canceled in the initial transit reservation, the future transit reservation may correspond to alternative flight B, which shares similar characteristics to flight A. The similar characteristics may include a similar destination and a similar duration.

In another exemplary embodiment, to automatically identify the future transit reservations, the historical information and the itinerary information may be recursively curated by using the model. The recursive curation may identify user preferences in the historical information and the itinerary information that are characterized by recurrence and/or repetition. For example, a user preference relating to seat selection may be determined by historical information indicating that a user repeatedly selected window seats on flights. Then, the API may be invoked to identify the future transit reservation based on an outcome of the curating. For example, the recursive curation may identify user preferences, which are then used together with the API to identify future transit reservations that match any combination of the user preferences.

In another exemplary embodiment, the model may use the historical information and the itinerary information to anticipate potential changes in the initial transit reservation. The model may proactively identify the future transit reservations in anticipation of a pending satisfaction of the predetermined threshold. For example, the model may use the historical information and the itinerary information to determine that there is a high probability that the initial transit reservation may result in a delay. The model may determine the high probability due to a particular flight being prone to delays or due to delays associated with a connecting flight.

In another exemplary embodiment, consistent with present disclosure, the API may include an external transit checker that is associated with an external computing environment. The external computing environment may include a first-party computing network that manages the future transit reservations. For example, the identified user preferences may be provided to a corresponding airline network via an airline API to facilitate identification of the future transit reservations. Alternatively, the external computing environment may include a third-party computing network that aggregates data from the first-party computing network. For example, the identified user preferences may be provided to a third-party data aggregator via an aggregator API to facilitate identification of the future transit reservations.

In another exemplary embodiment, a compatibility factor between the transit reservation and the future transit reservation may be determined. The compatibility factor may be determined by using the model. The compatibility factor may include variables that express how closely the future transit reservation reflects the initial transit reservation. Then, each of the future transit reservations may be scored based on the compatibility factor. The scoring may be determined by using the model and may reflect the compatibility. For example, a higher score may indicate a high compatibility between the future transit reservation and the initial transit reservation. Finally, each of the future transit reservations may be ranked based on the corresponding score. The future transit reservations may be ranked in ascending order as well as descending order based on the score. For example, the future transit reservations may be ranked in a top ten based on the score.

In another exemplary embodiment, the model may include at least one from among a machine learning model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S412, the identified future transit reservations may be provided to the users. The identified future transit reservations may be provided via a graphical user interface. In an exemplary embodiment, to provide the identified future transit reservations to the users, a hyperlink may be generated for each of the users. The hyperlink may enable access to a portal such as, for example, a web portal that includes a listing of the future transit reservations. The future transit reservations may be listed according to the ranking of the future transit reservations. In another exemplary embodiment, access to the portal may be governed by single factor authentication and multi-factor authentication of the user. Validation of the user may enable access to user persisted payment options, which enables quick payment without additional user input.

In another exemplary embodiment, the portal may be automatically refreshed based on a predetermined time to provide up-to-date future transit reservations. For example, the portal may be refreshed every thirty minutes to account for changes in the future transit reservations. In another exemplary embodiment, the portal may be manually refreshed by the user when additional parameters are provided. For example, the user may provide a preferred departure time and manually refresh the portal for relevant future transit reservations.

In another exemplary embodiment, the listing may include graphical elements that are configured to receive a user input to facilitate selection of one of the future transit reservations. For example, a user may interact with graphical element A to initiate selection of corresponding future transit reservation A. In another exemplary embodiment, the selections may initiate subsequent actions to confirm the corresponding future transit reservation. The actions may relate to subsequent automated steps that are completed without subsequent user input. For example, by selecting future transit reservation B, a flight with similar parameters may be automatically booked with an airline for the user without additional user input.

Then, a notification may be generated. The notification may include the hyperlink and information that relates to at least one from among the itinerary information, an output of the determining, and the operational status. For example, the notification may let the user know that a flight has been canceled, associated data relating to the cancelation, and the hyperlink with a list of alternate flights for rebooking. Finally, the generated notification may be provided to the users via the graphical user interface. In another exemplary embodiment, the generated notification may be provided via any communication channel. For example, the generated notification may be provided via email to the users.

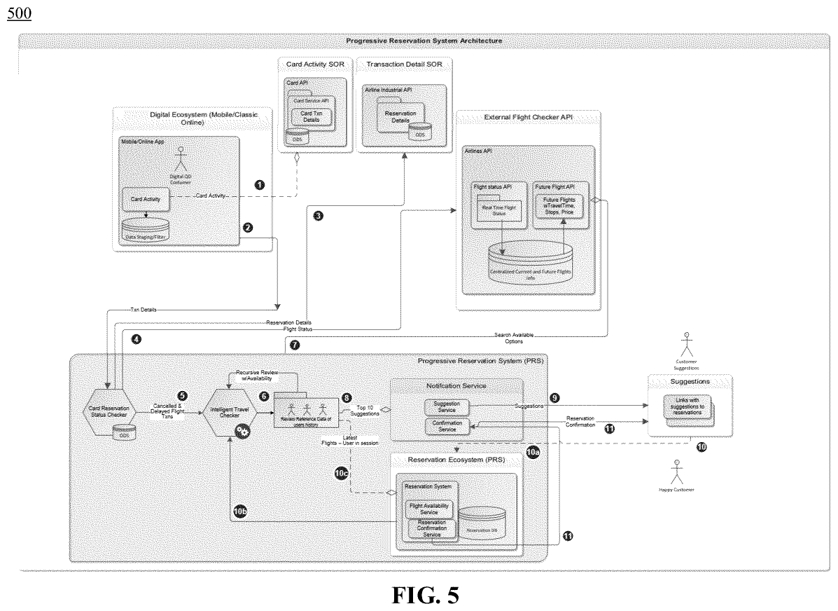

FIG. 5 is a system architecture diagram 500 of an exemplary process for implementing a method for facilitating intelligent itinerary management via a progressive reservation system that uses machine learning to recursively curate user data and automatically provide alternative recommendations. In FIG. 5, card modules may be implemented with a card reservation status checker, an intelligent travel checker, and a reservation system to perform actions consistent with present disclosures.

At step 1, the card modules may utilize services that monitor user card activities and get all card transaction details. At step 2, of all the aforementioned transactions, the travel related transactions may be filtered based on parameters such as, for example, transaction codes that are captured in the card details. Then, at step 3, the card reservation status checker may extract the detailed reservation information according to a card number, a transaction posted time, and a price. At step 4, based on the flight information received, the card reservation status checker may constantly poll for the status of the flights via an external flight checker application programming interface (API). When the reserved flight status is changed to either canceled or delayed by a predetermined threshold and/or a configurable system parameter, information may be passed to the intelligent travel checker at step 5.

At step 6, the intelligent travel checker may utilize machine learning models and artificial intelligence to recursively curate the user specific data from past reservations. The user specific data may include layover data, price data, time data, and user preference data. At step 7, the intelligent travel checker may search for future available flights with different options by invoking an external flight checker API. At step 8, based on a result of the searching, the intelligent travel checker may filter the result to identify a top ten suggestion that may be sent to a notification service. At step 9, the intelligent travel checker my utilize a suggestion service submodule to send out an email with links for each of the top ten options.

At step 10, the user may click the link to view all the options and related information in a web browser of the reservation system. In this process, various checks may be performed before the options are presented to the user. A first check at step 10a may present the options as is when it is determined that the user is viewing the results within thirty minutes of the send notification. A second check at step 10b may perform computations as listed in step 6 and step 7 when it is determined that the user is viewing the results after thirty minutes of the send notification. A third check at step 10c may determine that the user is already in an active session, and thus present the latest top ten options in the web browser for the user to review and select.

At step 11, after the user reviews and selects any one of the listed options to reserve, the reservation system may use a card authentication module together with multi-factor authentication to re-verify the identity of the user and proceed for confirmation of the itinerary. Once the reservation is completed, the reservation system may send out an email notification to confirm with the user.

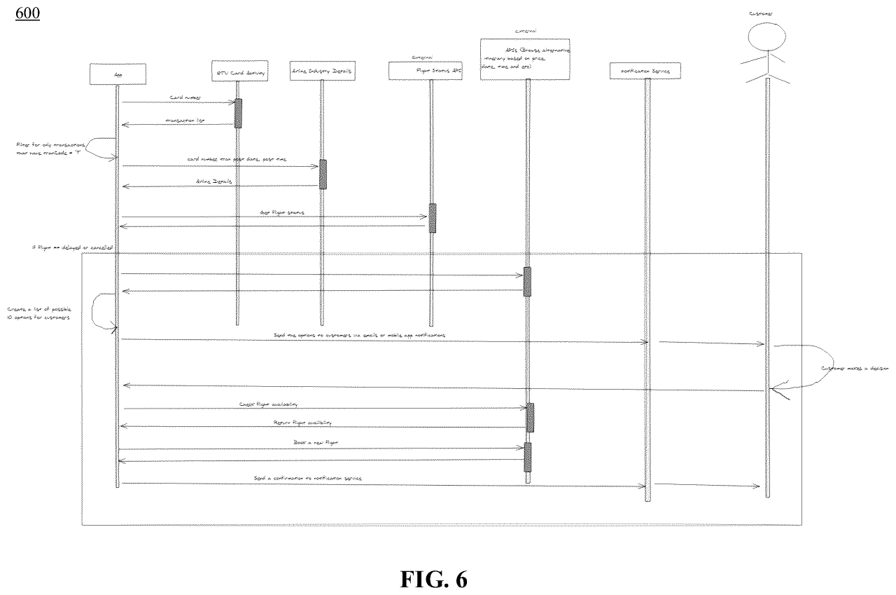

FIG. 6 is a system sequence diagram 600 of an exemplary process for implementing a method for facilitating intelligent itinerary management via a progressive reservation system that uses machine learning to recursively curate user data and automatically provide alternative recommendations. In FIG. 6, a sequence for performance of the claimed invention is presented consistent with present disclosures.

As illustrated in FIG. 6, an application may transmit a card number to a card activity module to retrieve a list of transactions that correspond to the card number. Consistent with present disclosures, the application may be configured to implement a method for facilitating intelligent itinerary management via a progressive reservation system that uses machine learning to recursively curate user data and automatically provide alternative recommendations. The application may filter the transaction list for particular types of transactions by using a predetermined transaction code such as, for example, a predetermined symbol that corresponds to each of the types of transactions.

The application may then provide a card number together with corresponding transaction post dates and post times to an airline industry details model. Using the provided information, the airline industry details module transmits corresponding airline details such as, for example, a flight number in an itinerary matching the transaction post date back to the application. The application may use the airline details to retrieve flight status information from an internal and/or external flight status application programming interface (API).

When the retrieved flight status information indicates that a flight is delayed or canceled, the application may communicate with an internal and/or an external API to browse for alternative itineraries with similar characteristics such as, for example, price, date, time, etc. The application may generate a list of possible options for rescheduling based on the alternative itineraries. Consistent with present disclosures, the list may include a top options listing such as, for example, a list of top ten possible options for rescheduling.

The application may engage a notification service to send the list of possible options to the customer via a customer preferred contact method such as, for example, an email and/or a mobile application notification. The customer may interact with the list of possible options to provide a selection via the customer preferred contact method. The application may receive the selection from the customer and interact with the internal and/or external API to check corresponding flight availability. Based on the flight availability information received from the internal and/or external API, the application may then schedule a new flight for the customer consistent with the customer selection. Based on a result of the scheduling, the application sends a confirmation to the customer via the notification service.

Accordingly, with this technology, an optimized process for facilitating intelligent itinerary management via a progressive reservation system that uses machine learning to recursively curate user data and automatically provide alternative recommendations is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating intelligent itinerary management via a progressive reservation system, the method being implemented by at least one processor, the method comprising:
aggregating, by the at least one processor, itinerary information for at least one user from a plurality of user transactions, the itinerary information corresponding to at least one transit reservation;
continuously monitoring, by the at least one processor in real-time via an application programming interface, each of the at least one transit reservation by using the itinerary information;
determining, by the at least one processor based on a result of the continuous monitoring, whether at least one parameter that corresponds to the at least one transit reservation satisfies a predetermined threshold, the at least one parameter including an operational status;
automatically retrieving, by the at least one processor from a repository, historical information that corresponds to the at least one user when the at least one parameter satisfies the predetermined threshold;
automatically identifying, by the at least one processor in real-time using at least one model, at least one future transit reservation based on the itinerary information and the historical information; and
providing, by the at least one processor via a graphical user interface, the identified at least one future transit reservation to the at least one user.

2. The method of claim 1, wherein the itinerary information includes at least one from among passenger information, real-time departure information, real-time arrival information, transit location information, terminal information, gate information, transit duration information, and real-time transit status information.

3. The method of claim 1, wherein aggregating the itinerary information from the plurality of user transactions further comprises:
continuously monitoring, by the at least one processor in real-time, transaction activities of the at least one user, the transaction activities including at least one electronic purchasing activity;
retrieving, by the at least one processor, transaction data for each of the at least one electronic purchasing activity;
filtering, by the at least one processor, the transaction data to identify at least one travel related transaction; and
extracting, by the at least one processor, the itinerary information from each of the identified at least one travel related transaction.

4. The method of claim 1, wherein the operational status includes at least one from among an on-time status, a delayed status, and a canceled status.

5. The method of claim 1, wherein the historical information includes user specific data from a plurality of past reservations, the user specific data including at least one from among departure location data, destination location data, price data, traversal time data, and user preference data.

6. The method of claim 1, wherein automatically identifying the at least one future transit reservation further comprises:
recursively curating, by the at least one processor using the at least one model, the historical information and the itinerary information; and
invoking, by the at least one processor, the application programming interface to identify the at least one future transit reservation based on an outcome of the curating, the application programming interface including an external transit checker.

7. The method of claim 6, further comprising:
determining, by the at least one processor using the at least one model, a compatibility factor between the at least one transit reservation and the at least one future transit reservation;
scoring, by the at least one processor using the at least one model, each of the at least one future transit reservation based on the compatibility factor; and
ranking, by the at least one processor, each of the at least one future transit reservation based on the corresponding score.

8. The method of claim 1, wherein providing the identified at least one future transit reservation to the at least one user further comprises:
generating, by the at least one processor, a hyperlink for the at least one user, the hyperlink enabling access to a portal that includes a listing of the at least one future transit reservation for selection;
generating, by the at least one processor, a notification, the notification including the hyperlink and information that relates to at least one from among the itinerary information, an output of the determining, and the operational status; and
providing, by the at least one processor via the graphical user interface, the generated notification to the at least one user.

9. The method of claim 1, wherein the at least one model includes at least one from among a machine learning model, a mathematical model, a process model, and a data model.

10. A computing device configured to implement an execution of a method for facilitating intelligent itinerary management via a progressive reservation system, the computing device comprising:
a processor;
a memory; and
a communication interface coupled to each of the processor and the memory, wherein the processor is configured to:
aggregate itinerary information for at least one user from a plurality of user transactions, the itinerary information corresponding to at least one transit reservation;
continuously monitor, in real-time via an application programming interface, each of the at least one transit reservation by using the itinerary information;
determine, based on a result of the continuous monitoring, whether at least one parameter that corresponds to the at least one transit reservation satisfies a predetermined threshold, the at least one parameter including an operational status;
automatically retrieve, from a repository, historical information that corresponds to the at least one user when the at least one parameter satisfies the predetermined threshold;
automatically identify, in real-time by using at least one model, at least one future transit reservation based on the itinerary information and the historical information; and
provide, via a graphical user interface, the identified at least one future transit reservation to the at least one user.

11. The computing device of claim 10, wherein the itinerary information includes at least one from among passenger information, real-time departure information, real-time arrival information, transit location information, terminal information, gate information, transit duration information, and real-time transit status information.

12. The computing device of claim 10, wherein, to aggregate the itinerary information from the plurality of user transactions, the processor is further configured to:
continuously monitor, in real-time, transaction activities of the at least one user, the transaction activities including at least one electronic purchasing activity;
retrieve transaction data for each of the at least one electronic purchasing activity;
filter the transaction data to identify at least one travel related transaction; and
extract the itinerary information from each of the identified at least one travel related transaction.

13. The computing device of claim 10, wherein the operational status includes at least one from among an on-time status, a delayed status, and a canceled status.

14. The computing device of claim 10, wherein the historical information includes user specific data from a plurality of past reservations, the user specific data including at least one from among departure location data, destination location data, price data, traversal time data, and user preference data.

15. The computing device of claim 10, wherein, to automatically identify the at least one future transit reservation, the processor is further configured to:
recursively curate, by using the at least one model, the historical information and the itinerary information; and
invoke the application programming interface to identify the at least one future transit reservation based on an outcome of the curating, the application programming interface including an external transit checker.

16. The computing device of claim 15, wherein the processor is further configured to:
determine, by using the at least one model, a compatibility factor between the at least one transit reservation and the at least one future transit reservation;
score, by using the at least one model, each of the at least one future transit reservation based on the compatibility factor; and
rank each of the at least one future transit reservation based on the corresponding score.

17. The computing device of claim 10, wherein, to provide the identified at least one future transit reservation to the at least one user, the processor is further configured to:
generate a hyperlink for the at least one user, the hyperlink enabling access to a portal that includes a listing of the at least one future transit reservation for selection;
generate a notification, the notification including the hyperlink and information that relates to at least one from among the itinerary information, an output of the determining, and the operational status; and
provide, via the graphical user interface, the generated notification to the at least one user.

18. The computing device of claim 10, wherein the at least one model includes at least one from among a machine learning model, a mathematical model, a process model, and a data model.

19. A non-transitory computer readable storage medium storing instructions for facilitating intelligent itinerary management via a progressive reservation system, the storage medium comprising executable code which, when executed by a processor, causes the processor to:
aggregate itinerary information for at least one user from a plurality of user transactions, the itinerary information corresponding to at least one transit reservation;
continuously monitor, in real-time via an application programming interface, each of the at least one transit reservation by using the itinerary information;
determine, based on a result of the continuous monitoring, whether at least one parameter that corresponds to the at least one transit reservation satisfies a predetermined threshold, the at least one parameter including an operational status;
automatically retrieve, from a repository, historical information that corresponds to the at least one user when the at least one parameter satisfies the predetermined threshold;
automatically identify, in real-time by using at least one model, at least one future transit reservation based on the itinerary information and the historical information; and
provide, via a graphical user interface, the identified at least one future transit reservation to the at least one user.

20. The storage medium of claim 19, wherein the itinerary information includes at least one from among passenger information, real-time departure information, real-time arrival information, transit location information, terminal information, gate information, transit duration information, and real-time transit status information.
